(19) United States
(12) Patent Application Publication
(10) Pub. No.: US 2007/0067631 A1
(43) Pub. Date: Mar. 22, 2007

(54) Method for authentication

(75) Inventor: Dirk Westhoff, Heidelberg (DE)

Correspondence Address: YOUNG & THOMPSON, 745 SOUTH 23RD STREET, 2ND FLOOR, ARLINGTON, VA, 22202, US

(73) Assignee: NEC Corporation, Tokyo (JP)

(21) Appl. No.: 11/519,929

(22) Filed: Sep. 13, 2006

(30) Foreign Application Priority Data
Sep. 20, 2005 (DE) 10 2005 044 949.2

(51) Int. Cl. H04L 9/00

(52) U.S. Cl. 713/168

(57) ABSTRACT

A method for authentication between at least two nodes within a network, preferably a wireless sensor network, is disclosed. The sending node computes a t-bit long hash value by using a hash function h. A transmission of possibly few additional data over the network is designed in such a way that from the sending node to the receiving node only t-k bits of the hash value are transferred as truncated hash value, whereby k is a fix but arbitrary natural number between 1 and t-1. The transmitted hash value is compared to a computed hash value at the receiving node.

### BACKGROUND OF THE INVENTION

1. Field of the Invention

The present invention relates to a method for authentication between at least two nodes within a network, preferably a wireless sensor network, wherein the sending node computes a t-bit long hash value by using a hash function h.

2. Description of the Related Art

In most networks, the reliability and security of data transfer is a central requirement. This includes on the one hand that the data is transmitted reliably from the sending node to the receiving node, on the other hand injecting data packets or manipulating the transmitted data by unauthorized persons has to be excluded or prevented. In particular in case of wireless networks these requirements are of essential importance because wireless networks are almost impossible to protect physically against unauthorized access. Depending on the area of application a prevention of wiretapping of the transmitted data is important in addition.

A big variety of methods to secure data transmission are known in practice. On the one hand sophisticated protocols for access control are used, and on the other hand adequate security mechanisms protect the transmitted data. A manipulation of data during transmission or an unauthorized injection of data in the network is hampered by different methods for authentication and signing. Spying out the transmitted data can efficiently be prevented by an encryption of the data. For this end, methods as, for example, according to PGP (Pretty Good Privacy), S/MIME (Secure/Multipurpose Internet Mail Extension) or DSA (Digital Signature Algorithm) can be utilized. In the area of authentication methods in restrictive environments, it should—as an example—be referred to the works of R. Anderson, “A family of new authentication protocols”, in: Operating System Review 32(4):9-20, or F. Stanjano, R. Anderson, “The Resurrecting Duckling: Security Issues in Ad-Hoc Wireless Networks”, 3^{rd} ATT Software Symposium, 1999.

With methods for authentication, signing and/or encryption a message to be transmitted is amended by additional information which enables an unambiguous mapping of the message to a sender, which shows a correct and manipulation-free transmission and/or makes the message during transmission illegible. All of these effects incur that considerable redundancy of the transmitted message is always added.

In case of many network connections the additionally transmitted amount of data is not critical, because there is enough bandwidth available. In case of a wireless sensor network though, in general rather low-bandwidth network connections are implemented. In addition to the performance capability of the processors to compute the authentication identifiers, the signature or the encrypted message, the power resources are also very restricted. Since many methods require considerable computational power, they are already discarded for this reason. Authentication methods that can be computed fast, such as MAC (Message Authentication Code) often have the disadvantage that the produced redundancy is relatively high. Currently, there is no method known that could achieve a solution to these contrary goals in a satisfying manner.

### SUMMARY OF THE INVENTION

Hence, the present invention is based on the task to design and further develop a method of the above-mentioned kind in such a way that a simple computation of the additional information is possible, that the network is charged by the transmission of possibly few additional data and that a secure authentication is still possible.

According to the invention, the task mentioned above is solved by a method showing the characteristics of claim 1. According to this, the proposed method for authentication is characterized in that from the sending node to the receiving node only t-k bits of the hash value are transferred as truncated hash value, whereby k is a fix but arbitrary natural number between 1 and t-1, and whereby the transmitted hash value is compared to a computed hash value at the receiving node.

According to the invention, it has first been recognized that in order to achieve a sufficiently secure authentication of the message a huge amount of additional amount of bits is not inevitably necessary. In contrast, a relatively low number of bits that complicates guessing the correct sequence of bits within the authentication identifier by a good choice of the bit sequence is sufficient. The method according to the invention applies a hash function that is simple to compute. A t-bit long hash value is generated by the hash function. According to the invention, for authentication of the message not all of the t bits are transmitted. In contrast, when transmitting only a much smaller part of the hash value is considered. In order to do so, t-k bits of the hash value are cut out and used for authentication. The value of k is a relatively arbitrary natural number between 1 and t-1, keeps in general its fix value after initial definition. The truncated hash value is transmitted to the receiving node and there compared to a computed hash value and with this then an authentication is performed. By an authentication with t-k bits of the hash value the potential number of collisions increases, but there are still up to 2^{t-k} trials necessary to generate randomly a fitting authentication identifier.

Collisions are such cases where in spite of different seeds in the hash function, the same hash value results in the end. Since not only t bits, but only t-k bits have to be sent in addition to the message to be transmitted the network connection can be used much more efficiently. In spite of the very small additional effort a very efficient authentication can be achieved by the method according to the invention. The method according to the invention is extremely power-saving due to a simple computation of the hash value and a significantly reduced load of the network connection caused by the authentication. In addition it provides a protection against DoS (denial of service) attacks.

Preferably a truncated hash value is generated by using t-k sequential bits. The selection becomes very easy if the first t-k bits of the computed hash value are chosen. Since a lot of systems, in particular in the area of the wireless sensor systems, do such computations by using a micro-controller, the usage of the first bits can be realized very easily. They are mostly processors with an 8-bit or 16-bit storage, so the hash value can easily be truncated by simply using the storage component, which stores the first bits of the hash value. It should be noted though that any other arbitrary t-k bits can be chosen from the hash value. It does not matter which bits of the hash value are used. In particular, the bits do not indispensably have to follow each other sequentially. The only precondition is that before starting the system the sending node and the receiving node know the rule according to which the bits are chosen from the hash value.

Regarding a possibly effective reduction of the transmitted amount of data k is preferably chosen in such a way that the truncated hash value has a length of roughly 8 bits. Typically, the length of hash values is 80 to 160 bits, which stresses the tremendous potential for a reduction of the transmitted amount of data. Since in general the transmission of individual bits represents a similar or higher expense as the execution of a processor instruction, the method according to the invention reduces the expense massively.

In order to achieve a possibly high level of security of the computed authentication identifier, preferably a keyed hash function is used as hash function. Keyed hash functions are hash functions whose result does not only depend on the seed, but additionally on a key selected for computing. Applying a keyed hash function becomes especially effective if for each authentication another key is used as parameter for the keyed hash function.

In order to avoid the need to store a multitude of keys separately at the sending node and at the receiving node, multiple keys can be internally generated at each node from a common seed x₀ by repeatedly applying hash function. The i-th authentication is computed by a hash value Xₙ₋ᵢ, where xₙ₋ᵢ is calculated by applying hash function by a (n-i) times to the seed x₀. The hash function is here defined in such a way that a hash value xⱼ₊₁ is computed by applying the hash function to a hash value xⱼ. An inverse function of a hash function can not be defined by the specific selection of the function, i.e. by knowing the hash value xⱼ even with a present hash function the hash value xⱼ₋₁ cannot be inferred without very much effort.

Hence, the hash values are used in inverse order, thereby the number of iterative computations decreases with each authentication.

Since in case of an authentication identifier not only an authentication of the sender should be possible, but also a manipulation-free transmission of the message should be verified, the authentication identifier could depend on the transmitted message. This is the reason why the keyed hash function receives the message as parameter and computes a hash value that depends on the message and the key. The hash value computed in this way is then truncated correspondingly and transmitted along with the message to be transmitted to the receiving node.

Advantageously, not only the sending node knows the seed x₀, the hash function and the number n of iterations of the application of the hash function. This data should in contrast be announced to the receiving node as well. Preferably, this takes place before starting the system. The easiest way would be when producing the individual devices.

An authentication identifier could also be computed at the receiving node, based on the received message, on the hash functions stored there, the seed x₀ and the number n. Here, in an advantageous way the same or at least comparable computation steps are applied as used at the sending node. The authentication identifier computed at the receiving node serves then as computed hash value and is used for authentication of the received message. If both hash values match, it is assumed that the received message comes from the indicated sender and has not been manipulated.

In this case the information and/or instructions contained in the message are further processed. If the two hash values differ the received message is discarded. By these means, certain robustness against DoS attacks can be achieved.

Now, there are several options of how to design and to further develop the teaching of the present invention in an advantageous way. For this purpose, it must be referred to the claims subordinate to claim 1 on the one hand and to the following explanation of a preferred example of an embodiment of the invention together with the figure on the other hand. In connection with the explanation of the preferred example of an embodiment and the figure, generally preferred designs and further developments of the teaching will also be explained.

### BRIEF DESCRIPTION OF THE DRAWING

FIG. 1 is a diagram showing a scheme of a system to implement a method according to the invention.

### DESCRIPTION OF THE PREFERRED EMBODIMENT

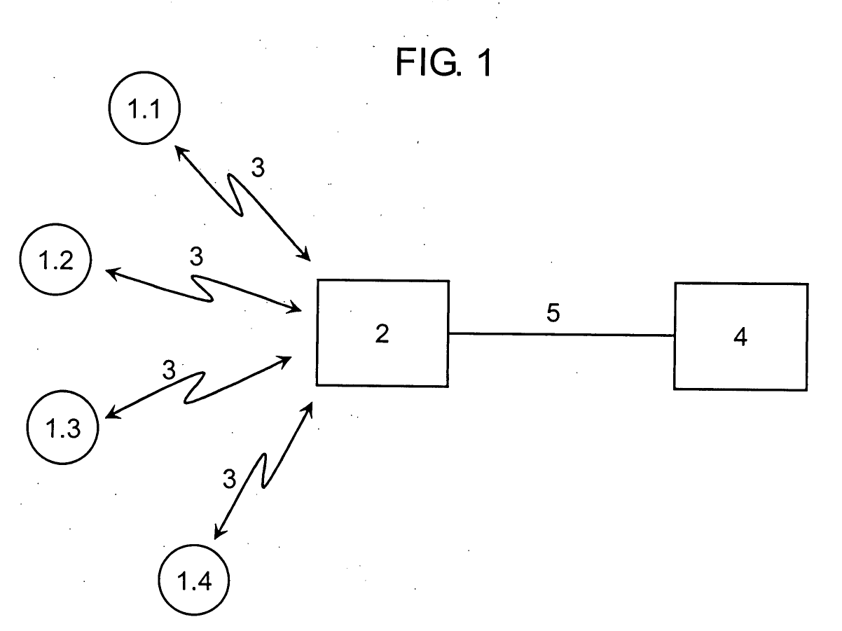

FIG. 1 shows in a scheme a wireless sensor network that can be used to implement a method according to the invention. Several sensor nodes 1 are connected over wireless network connections 3 to a sink 2. To this sink 2 a distant computer 4 is connected over a wired connection 5.

Before installing the wireless sensors 1, a seed x₀, a keyed hash function h to compute the authentication identifier, a further hash function to generate the key and the maximum number n of iterations to apply the further hash function, is stored.

The keyed hash function his a MAC (Message Authentication Code), the further hash function is designed to generate Lamport's hash values. It holds that from a hash value xⱼ a hash value xⱼ₊₁ can be computed by applying a further hash function, wherein x₀ serves as seed. In addition, to reduce the computation effort for a certain number of applications of the further hash function, for example 64 subsequent computations, interim values of the hash values can be stored. The sink 2 receives also a copy of the respective values and functions.

As an example, a retrieval of a sensor value is to be started at sensor 1.2 and then forwarded over sink 2 to the distant computer 4. In order to do so, the sink 2 starts a corresponding request at sensor 1.2. The request is first coded and then encrypted to safeguard it against unauthorized wiretapping. Because the encryption method does not matter in this context, it is assumed that an arbitrary method known in practice is used. It should only be secured that possibly few additional redundancy is amended by the chosen encryption method. The encrypted request eventually forms the message to be sent to the sensor.

In order to compute the authentication identifier, first of all a key is selected. To do so, it is checked how many requests have been done since starting the system. This number i could be stored in an appropriate register. By applying (n-i) times the further hash function on the seed x₀, a hash value xₙ₋ᵢ is computed as key.

After the key is there, it is handed over to the keyed hash function h and applied to the message. The result of the computation is here called MAC (m, xₙ₋ᵢ). After that, the t-k first bits of the hash value are cut out and concatenated with the message m to a new message <m, (t-k)−MAC (m, xₙ₋ᵢ)>, wherein (t-k)−MAC (m, xₙ₋ᵢ) means the t-k first bits of the hash value MAC (m, xₙ₋ᵢ). This new message is finally transmitted to the sensor node 1.2.

The sensor node 1.2—in this case the receiving node—extracts the message m′ from the received message and computes also the value xₙ₋ᵢ with the value of i that is known to the sensor node. To do so, the values and hash functions are used that were stored in the sensor before installing the network. In the receiving node the hash value MAC (m′, xₙ₋ᵢ) for the received message is determined. After cutting out the first t-k bits of the hash value, the truncated hash value is compared to the received hash value. If both truncated hash values match, the request is processed and the measured value or a further message is transmitted to the sink as apart of a protocol which maybe necessary, depending on the circumstances. By doing so the role of the sending node and receiving node swaps. The sensor becomes the sending node, the sink becomes the receiving node.

If the hash values do not match, the process can be repeated for the next hash value xₙ₋ᵢ₋₁. Since xₙ₋ᵢ₋₁ has already been computed, only MAC (m′, xₙ₋ᵢ₋₁) needs to be determined. This makes sense because in a wireless network requests could not be received by the addressee. If necessary, these computations can be repeated within a given frame with further hash values. If a correct hash value is found, the request can be processed. The sink should be informed about the changed request number.

Finally, it is particularly important to point out that the completely arbitrarily chosen example of an embodiment of the teaching according to the invention from above only serves as illustration of the teaching as according to the invention, but that it does by no means restrict the latter to the given example of an embodiment.

1. A method for authentication between at least two nodes within a network, preferably a wireless sensor network, wherein the sending node computes a t-bit long hash value by using a hash function h, wherein from the sending node to the receiving node only t-kbits of the hash value are transferred as truncated hash value, whereby k is a fix but arbitrary natural number between 1 and t-1 , and whereby the transmitted hash value is compared to a computed hash value at the receiving node.

2. The method according to claim 1, wherein in order to determine the truncated hash value t-k sequential bits, preferably the first t-k bits of the hash value are used.

3. The method according to claim 1, wherein k is chosen in such a way that the truncated hash value shows a length in the range of about 8 bits.

4. The method according to claim 1, wherein a keyed hash function is used as hash function h.

5. The method according to claim 4, wherein with each authentication another key is used as parameter for the keyed hash function h.

6. The method according to claim 4, wherein a hash value xₙ₋ᵢ computed by a further hash function is used for the i-th authentication as key for the keyed hash function h.

7. The method according to claim 6, wherein the hash value xₙ₋ᵢ is computed by iterative application of the further hash function of a seed x₀ wherein a hash value xⱼ₊₁ is computed from a hash value xⱼ by applying the further hash function once.

8. The method according to claim 4, wherein the keyed hash function is handed over to the message to be transmitted as parameter.

9. The method according to claim 8, wherein the hash value computed by the hash function h depends on the message handed over.

10. The method according to claim 1, wherein the message is transmitted along with the truncated hash value from the sending node to the receiving node.

11. The method according to claim 1, wherein the computed hash value is computed at the receiving node.

12. The method according to claim 11, wherein the computed hash value is computed by using the received message.

13. The method according to claim 1, wherein the same or at least comparable computation steps are applied to compute the computed hash value as at the sending node.

14. The method according to claim 1, wherein the sending node and the receiving node know the seed x₀, the two hash functions and the number n of potential applications of the further hash function to the seed.
